(19) United States
(12) Patent Application Publication
(10) Pub. No.: US 2006/0265963 A1
(43) Pub. Date: Nov. 30, 2006

(54) Manipulable engagement assemblies for barrier panels

(76) Inventor: Jay Winborn, Berkley, MI (US)

Correspondence Address: BUTZEL LONG, 350 SOUTH MAIN STREET, SUITE 300, ANN ARBOR, MI, 48104, US

(21) Appl. No.: 11/241,124

(22) Filed: Sep. 30, 2005

Related U.S. Application Data
(63) Continuation-in-part of application No. 11/134,942, filed on May 23, 2005.
(63) Continuation-in-part of application No. 11/214,483, filed on Aug. 29, 2005.

(51) Int. Cl. B60J 5/04

(52) U.S. Cl. 49/502

(57) ABSTRACT

Barrier liner panels for a motor vehicle door assembly that include engaging structures that engage the peripheral edge of an opening formed in a door panel. The engaging structures include structural elements that move between open and closed positions

### RELATED APPLICATIONS

The present application is a Continuation-In-Part of U.S. patent application Ser. No. 11/134,942, filed May 23, 2005 entitled “Automobile Door Assemblies” and of U.S. patent application Ser. No. 11/214,483, filed Aug. 29, 2005, entitled “Multi-Sheet Barrier Panel for Automobile Door Assemblies,” to each of which priority is claimed under 35 U.S.C. §120 and of each of which the entire specification is hereby expressly incorporated by reference.

### TECHNICAL FIELD

The present invention relates to vehicle door water shield barriers which prevent the ingress of water, sound, dust and air into a vehicle passenger compartment. More particularly, according to one embodiment, the present invention relates to barrier panels for vehicle door assemblies that include engagement structures that are configured to align and secure the barrier panels directly to door panels.

### BACKGROUND ART

Automobile door assemblies generally include a door panel to which an inner trim panel is joined. The door panel includes a cavity within which the door window may be lowered. This cavity may also contain window regulating equipment, door locks, sound speakers, air bag systems, and the like. The inner trim panel is typically a rigid or semi-rigid panel formed of a cloth-like or plastic trim material which serves as the interior passenger compartment panel.

Door assemblies are susceptible to the ingress of water which can enter into door cavities through the openings through which the door windows slide. Holes are generally formed in the bottom of door assemblies to allow any water that enters the door cavities to drain out. However, as water enters door cavities and runs down toward the drain holes, it can seep into and through the inner trim panels unless a barrier of some type is provided in the assembly.

In order to protect inner trim panels from becoming wet and possibly stained or otherwise damaged, it is common to attach panel liners over door panels beneath inner trim panels. Such panel liners are often made of a treated paper material or can comprise a thin plastic film. The panel liners function to deflect any water entering door cavities so that the water runs down the liners to the bottoms of the door cavities without contacting the inner trim panels.

Liners used in door assemblies are typically sealed to the door panels of door assemblies by an adhesive which is provided as a bead that extends along the periphery of the liners. In order to protect the adhesive bead, a release sheet is secured to the liners over the adhesive bead. The release sheet has to be removed when a liner is applied to a door panel of a door assembly.

Inner trim panels of door assemblies are typically attached to door panels by a plurality of push-in fasteners that are commonly referred to as “Christmas trees.” The push-in fasteners extend outward from the outboard side of the inner trim panels and are spaced apart adjacent the peripheral edge of the inner trim panels. The inboard surface of the door panels include through-holes which are aligned to receive the push-in fasteners provided on the inner trim panels. The inner trim panels are attached to the door panels by aligning and pushing the push-in fasteners on the inner trim panels into the through-holes in the door panels.

When assembling door assemblies liners are often attached to the inner trim panels by the plurality of push-in fasteners with the outboard side of the barrier panels having the adhesive bead facing the door panels. The push-in fasteners hold and align the liners in position until the push-in fasteners are received in the through-holes in the door panels. Since it typically requires more push-in fasteners to secure an inner trim panel to a door panel than is necessary to hold the barrier panels in position, it is common in door assemblies to have tolerance variances between the inner trim panel and door panels.

The present invention provides for barrier panels that are configured and designed to attach directly to door panels and thereby avoid having to hold the barrier panels to the outboard surface of inner trim panels during the assembly of a door assembly.

### DISCLOSURE OF THE INVENTION

According to various features, characteristics and embodiments of the present invention which will become apparent as the description thereof proceeds, the present invention provides a barrier panel for a vehicle door assembly having a door panel, which barrier panel includes:

a sheet of substantially water-impermeable material that is substantially complimentarily shaped to the door panel and includes an inboard surface and an outboard surface; and

at least one engaging structure provided on the outboard surface of the sheet of substantially water-impermeable material and being configured to engage a peripheral edge of an opening formed in an inboard surface of the door panel, the at least one engaging structure having a portion that is stationary with respect to the sheet of substantially water-impermeable material and a portion that is movable with respect to the sheet of substantially water-impermeable material between an open position in which the at least one engaging structure does not engage the opening formed in an inboard surface of the door panel and a closed position in which the at least one engaging structure engages the opening formed in an inboard surface of the door panel.

The present invention further provides an engaging structure provided on a barrier panel of a door assembly that includes:

a movable portion having a base provided with an engaging lip and a deflector; and

a latch element that is stationary with respect to the barrier panel and configured to engage the movable portion.

### BRIEF DESCRIPTION OF DRAWINGS

The present invention will be described with reference to the attached drawings which are given as non-limiting examples only, in which:

FIG. 1 is an exploded perspective view of a conventional motor vehicle door assembly that includes a barrier panel.

FIG. 2 is an exploded perspective view of a motor vehicle door assembly that includes a barrier panel according to another embodiment of the present invention.

FIG. 3A is an elevational view of a door assembly showing a barrier panel according to one embodiment of the present invention in phantom.

FIG. 3B is a sectional view of the door assembly of FIG. 3A taken along section lines II-II.

FIG. 3C is an enlarged view of the encircled portion of the door assembly illustrated in FIG. 3B.

FIG. 4 is an exploded perspective view of a motor vehicle door assembly that includes a barrier panel according to another embodiment of the present invention.

FIG. 5A is an elevational view of a door assembly showing a barrier panel according to one embodiment of the present invention in phantom.

FIG. 5B is a sectional view of the door assembly of FIG. 5A taken along section lines IV-IV.

FIG. 5C is an enlarged view of the encircled portion of the door assembly illustrated in FIG. 5B.

FIG. 6 is a top planar view of a barrier panel having an engagement structure according to another embodiment of the present invention.

FIG. 6A₁ is a perspective view of the engagement structure of FIG. 6 in the engagement structure's open position.

FIG. 6B₁ is a perspective view of the engagement structure of FIG. 6 in the engagement structure's closed position.

FIG. 6A₂ is a cross-sectional end view of the engagement structure of FIG. 6 in the engagement structure's open position.

FIG. 6B₂ is a cross-sectional end view of the engagement structure of FIG. 6 in the engagement structure's closed position.

FIG. 6A₃ is a rear view of the engagement structure of FIG. 6 in the engagement structure's open position.

FIG. 6B₃ is a front view of the engagement structure of FIG. 6 in the engagement structure's open position.

FIG. 7 is a top planar view of a barrier panel having an engagement structure according to another embodiment of the present invention.

FIG. 7A is a perspective view of the engagement structure of FIG. 7 in the engagement structure's closed position.

FIG. 7B is a planar top view of the engagement structure of FIG. 7.

FIG. 7C is a cross-sectional end view of the engagement structure of FIG. 7 in the engagement structure's open position.

FIG. 7D is a cross-sectional end view of the engagement structure of FIG. 7 in the engagement structure's closed position.

### BEST MODE FOR CARRYING OUT THE INVENTION

The present invention is directed to water seal or barrier panels (herein generally referred to as “barrier panels”) for vehicle door assemblies that include engaging structures for attaching the barrier panels to door panels during and after the assembly of a vehicle door assembly. The barrier panels of the present invention are configured to be received between an inner trim panel and a door panel of a door assembly and can include a bead of a conventional sealant/adhesive material to provide a peripheral seal against the door panels. Alternatively, a peripheral sealing element can be molded an integrated onto the outboard surface of the barrier panel. The barrier panels include a sheet of material that has a configuration which is complementary shaped to the inner or inboard surface of a door panel at least around the periphery thereof and include engaging structures that are configured and aligned to engage the edge of one or more openings provided in the inboard surface of the door panels.

The barrier panels can be made from a variety of moldable materials such as polyethylene, polystyrene, abs plastics, polypropylene, foamable plastics, etc. and can comprise a single sheet or two or more sheets that are bonded together in a sealed and spaced apart manner at discrete portions. When the barrier panel comprises two or more sheets that are bonded together, areas in the space between adjacent sheets can be hollow or can contain or be filled with acoustic and/or thermal insulation materials such as noise absorbing materials or materials with low thermal conductivity.

The engaging structures, in whole or in part, can be molded into the barrier panels when they are fabricated and can comprise hollow, solid, or semi-hollow structures, or linked structures or assemblies. Alternatively, the engaging structures can be made separately from the barrier panels and attached or fixed thereto by adhesives, thermal or ultrasonic welding, mechanical fasteners, cooperating engaging structures, etc.

In general the engaging structures are arranged and aligned on the outboard surface of a barrier panel so that the engaging structures collectively engage a cutout or a plurality of cutouts provided in the inboard surface of a door panel.

The engaging structures help apply pressure toward the door panels which has the effect of pressing on the bead of sealant/adhesive materials thereby ensuring the production of a good seal thereby.

In door assemblies that include the barrier panels having engaging structures according to the present invention, the inner trim panels can be secured to the door panels by mechanical fasteners such as screws, clips, push-in fasteners, etc. generally in a conventional manner. However, it is not necessary for the mechanical fasteners to extend through the barrier panels. Accordingly, the inner trim panels extend beyond the periphery of the barrier panels and the through-holes in the door panels which receive the mechanical fasteners of the inner trim panels are spaced outward from the periphery of the barrier panels. Alternatively, the mechanical fasteners that are used to secure the inner trim panels to the door assemblies can extend through the barrier panels.

Features and characteristics of the present invention will be hereafter described with reference to the attached drawings which are provided as non-limiting examples only. Throughout the drawings, similar reference numerals are used to identify common elements when possible in order to simplify the description.

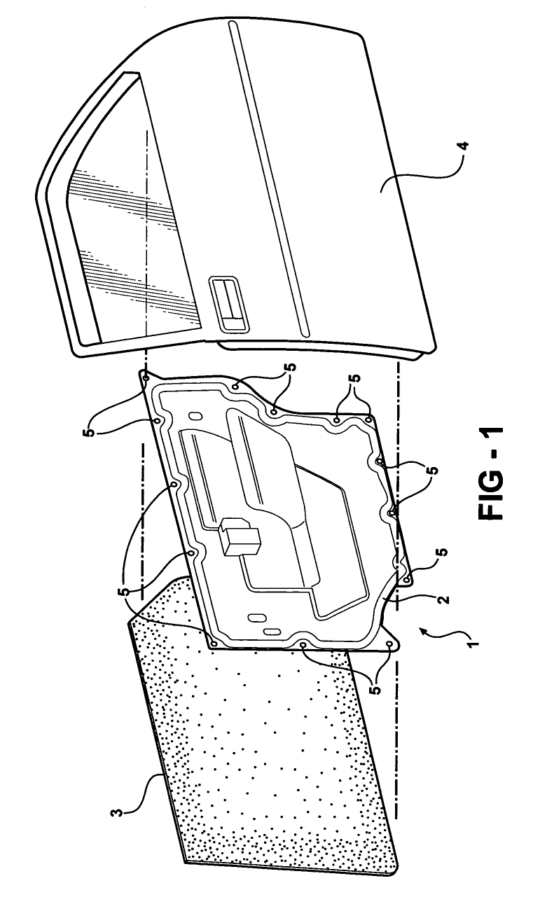

FIG. 1 is an exploded perspective view of a conventional motor vehicle door including a barrier panel. The barrier panel 1 includes a generally planer sheet that has been molded in the center so as to conform to, receive or accommodate various components of a vehicle door such as a door latching handle, window control mechanism, power seat control panel, etc. (none shown). A bead of a conventional sealant/adhesive 2 is disposed near the periphery of the barrier panel 1.

The barrier panel 1 is positioned between an inner trim panel 3 and door panel 4 of the vehicle door. The inner trim panel 3 is attached to the door panel 4 by a plurality of mechanical fasteners (not shown) which can pass through the through-holes 5 provided in the barrier panel 1.

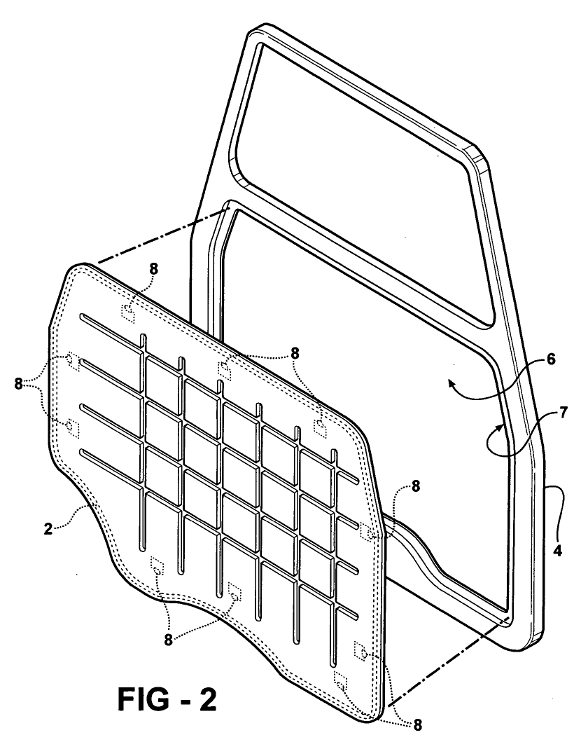

FIG. 2 is an exploded perspective view of a motor vehicle door assembly that includes a barrier panel according to one embodiment of the present invention. In FIG. 2 the door panel 4 is shown as having an opening 6 formed in the inboard side thereto. The opening 6 has a peripheral edge 7. The barrier panel 1 shown in FIG. 2 includes a plurality of engaging structures 8 that extend outwards from the outboard side thereof. The engaging structures 8 are spaced apart and aligned so that each will engage a portion of the peripheral edge 7 of the opening 6 formed in the inboard side of the door panel 4. The barrier panel 1 also includes a bead 2 of a conventional sealant/adhesive material that extends adjacent the periphery thereof on the outboard side. The adhesive bead 2 will contact the inboard side of the door panel 4 when the barrier panel 1 is moved into contact with the door panel 4 and the engaging structures 8 engage the peripheral edge 7 of opening 6. The engaging structures 8 and adhesive bead 2 both help hold the barrier panel 1 in place until an inner trim panel (not shown) can be attached to the door panel 4 over the barrier panel 1. Such an inner trim panel can be attached to the inboard surface of the door panel 4 using conventional fastening means such as screws, clips, push-in fasteners, panel fasteners, etc. The inner trim panel would typically extend beyond the peripheral edges of the barrier panel 1. The fastening means can fasten the inner trim panel to the door panel 4 by passing through through-holes provided in the peripheral edge of the barrier panel 1 or by passing beyond the peripheral edge of the barrier panel 1. It is noted that although the adhesive bead 2 is depicted as extending along the entire periphery of the barrier panel 1, it is possible to only provide an adhesive bead 2 that extends about a lower portion of the periphery of the barrier panel 1. Adhesives compositions that are useful of purposes of the present invention are known in the art.

The barrier panel 1 can be made from a variety of moldable, water impermeable materials such as polyethylene, polystyrene, abs plastics, polypropylene, foamable plastics, etc. and can comprise a single sheet or two or more sheets that are bonded together in a sealed and spaced apart manner at discrete portions. Also, as noted above, the barrier panel can comprise a single sheet or two or more sheets that are bonded together in a sealed and spaced apart manner at discrete portions. When the barrier panel 1 comprises two or more sheets that are bonded together, areas in the space between adjacent sheets can be hollow or can contain or be filled with acoustic and/or thermal insulation materials such as noise absorbing materials or materials with low thermal conductivity.

The inner trim panel 3 can be made from a relatively rigid material such as hard plastic, or a covered plastic or covered cellulose based material or composite thereof. The covering can be fabric, vinyl, cloth, thermoplastic olefins (TPO), leather, carpet or any combination thereof.

The center of barrier panel 1 shown in FIG. 2 can have any desired shape or configuration desired to conform to, receive or accommodate various components of a vehicle door such as a door latching handle, window control mechanism, power seat control panel, etc. (none shown).

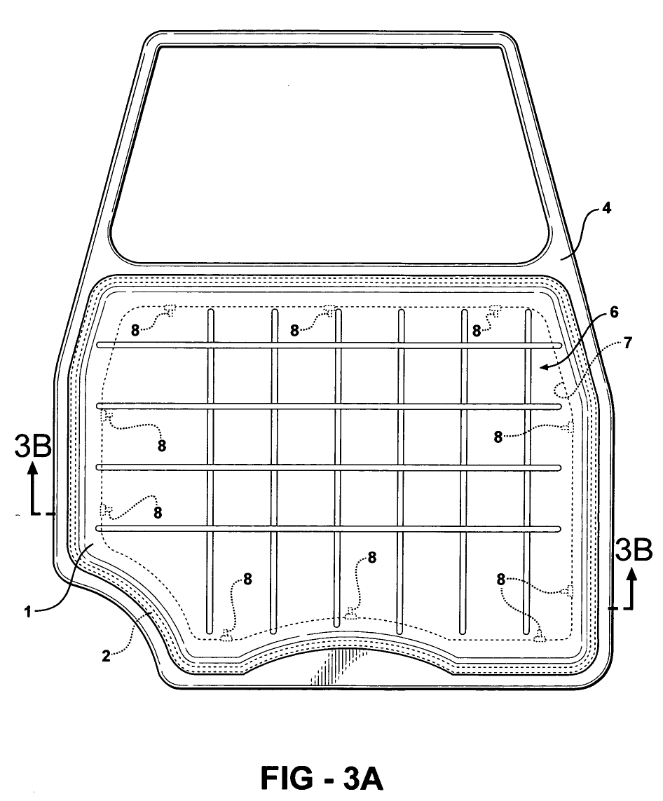

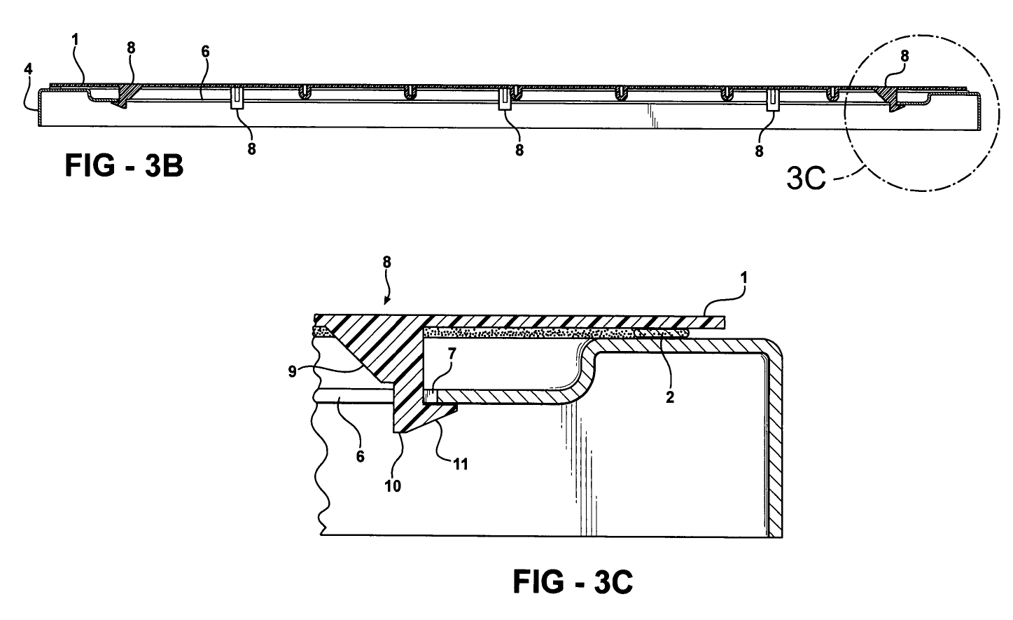

FIG. 3A is an elevational view of a door assembly showing a barrier panel according to one embodiment of the present invention in phantom. In FIG. 3A the alignment of the engaging structures 8 on the outboard surface of the barrier panel 1 with respect to the peripheral edge 7 of the opening 6 formed in the inboard surface of the door panel 4 can be seen. As noted above, the engaging structures 8 are spaced apart from one another and aligned so that each will engage a portion of the peripheral edge 7 of the opening 6 formed in the inboard side of the door panel 4. The number of engaging structures 8 and the distance that they are spaced apart can be varied depending on the configuration of the door panel 4 and the shape of opening 6. In some embodiments, instead of one opening 7 two or more openings can be provided in the inboard surface of the door panel 4 and engaging structures 8 can be arranged and aligned to engage peripheral edges of each of the openings. Moreover, one or more of the engaging structures 8 could be configured to be received in a through-hole provided in the inboard surface of the door panel 4. The depiction of the invention in FIG. 3A is intended to show the features of the barrier panel 1 in reference to the door panel 4. However, it is to be understood that in order to attach an inner trim panel to the assembly depicted in FIG. 3A, the peripheral edge of the door panel 4 would be slightly greater than the peripheral edge of the barrier panel 1 so as to provide a peripheral area where an inner trim panel could be attached to the door panel 4, over the barrier panel 1, using conventional fastener means.

FIG. 3B is a sectional view of the door assembly of FIG. 3A taken along section lines III-III. In FIG. 3B the manner in which the engaging structures 8 extend outward from the outboard surface of the barrier panel 1 in order to extend into the opening 6 formed in the inboard surface of the door panel 4 and engage the peripheral edge 7 of the opening 6 is depicted. FIG. 3C is an enlarged view of the encircled portion of the door assembly illustrated in FIG. 3B. The engaging structure 8 depicted in FIG. 3C is a solid structure that includes a base portion 9 that extends outward from the outboard surface of the barrier panel 1 and an end portion 10 that forms a catch that engages the edge 7 of opening 6 provided in door panel 4. The end portion 10 of the engaging structure 8 has a leading sloped or inclined surface 1 1 that helps deflect the engaging structure 8 inward so that the catch portion can slide by the peripheral edge 7 of opening 6. Once the catch portion clears the edge 7 of opening 6 it can engage the inner peripheral edge 7 of opening 6 as shown. The peripheral edge 7 of opening 6 can be recessed as depicted to accommodate the length of the engaging structures 8.

FIG. 3C shows the position of the adhesive bead 2 from FIG. 3A. As can be seen, the manner in which the engaging structure 8 pulls the barrier panel 1 toward the inboard surface of the door panel 4 causes pressure to be applied to the adhesive bead 2, thereby ensuring that a good seal is formed by the adhesive bead 2 which will contain moisture. It is to be understood that the amount of force created by the engaging structures 8, which at a minimum should be sufficient to hold the barrier panel 1 in place during assembly of a door assembly, is determined in part by the length of the engaging structures 8 and the amount the peripheral edge 7 of the opening 6 in a door panel 4 is recessed. Other determining factors include the number of engaging structures 8, the resilience of the material from which the engaging structures 8 and barrier panel 1 are made, the configuration and arrangement of the engaging structures 8, etc.

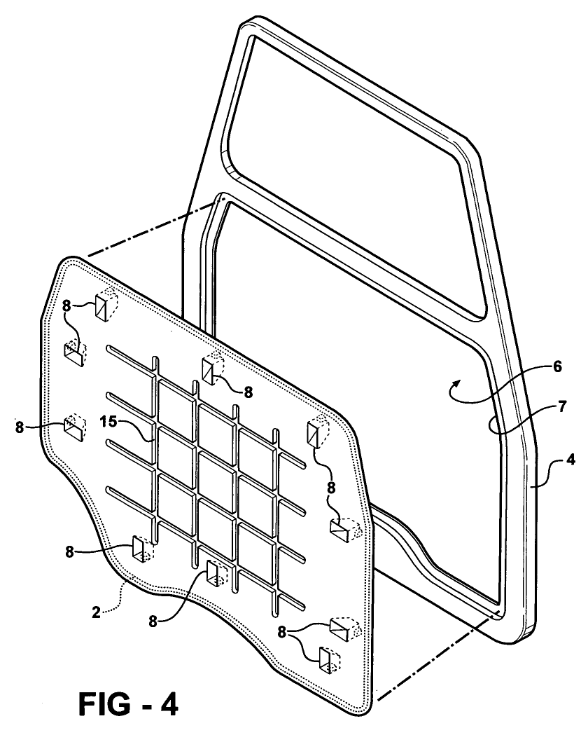

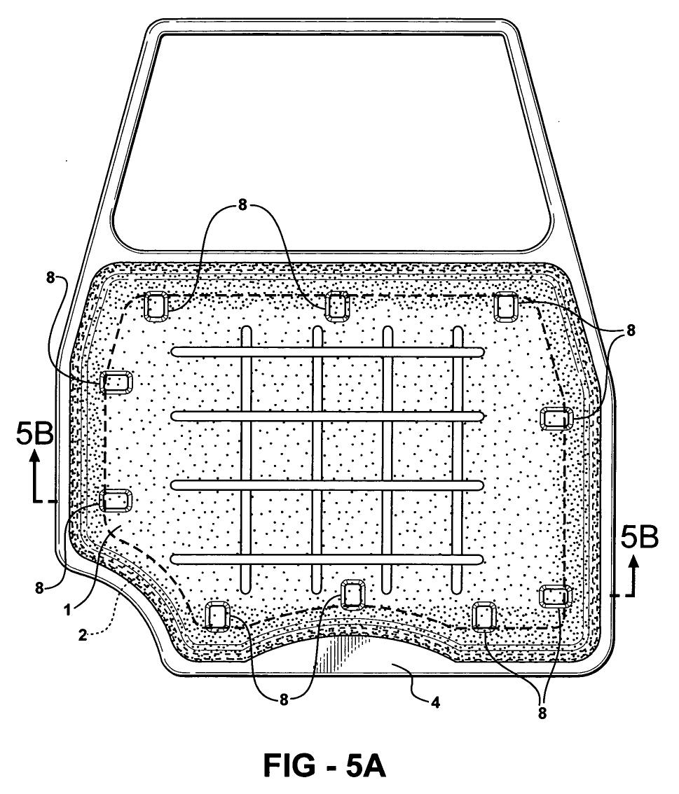

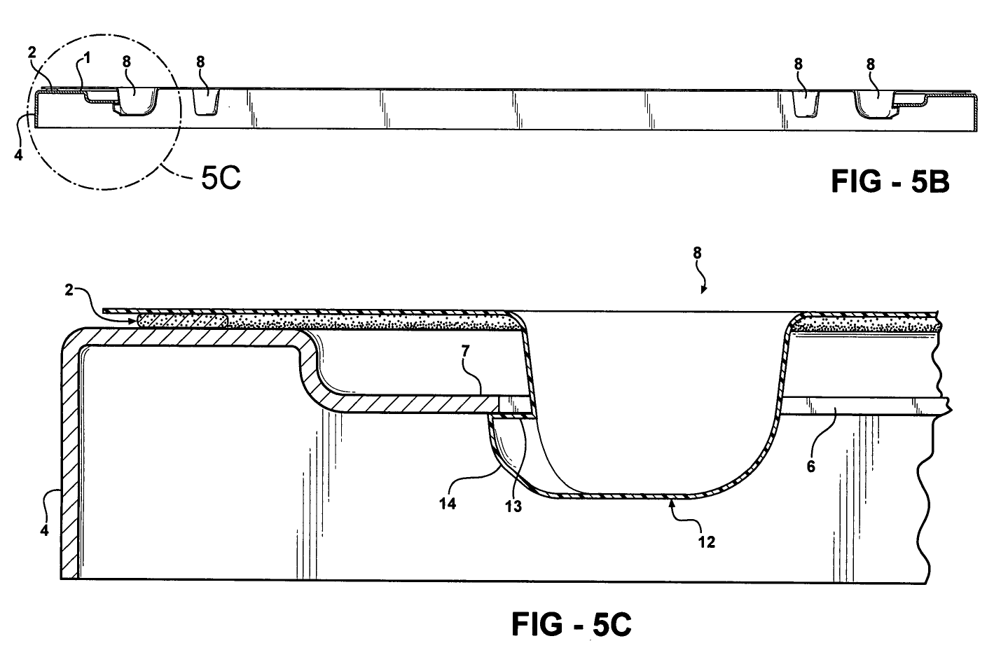

FIG. 4 is an exploded perspective view of a motor vehicle door assembly that includes a barrier panel according to another embodiment of the present invention. The engaging structures depicted in FIG. 4 have hollow base portions which are described in more detail in reference to FIGS. 5A-5C.

FIG. 5A is an elevational view of a door assembly showing a barrier panel according to one embodiment of the present invention. FIG. 5B is a sectional view of the door assembly of FIG. 5A taken along section lines IV-IV. FIG. 5C is an enlarged view of the encircled portion of the door assembly illustrated in FIG. 5B.

The embodiment of the invention depicted in FIGS. 4-5C is quite similar to the embodiment of the invention depicted in FIGS. 2-3C. The major difference is the shape and configuration of the engaging structures. In FIGS. 2-3C, the engaging structures 8 are solid structures. In FIGS. 4-5C the engaging structures 8 are hollow structures or at least have hollow bases. As best seen in FIG. 5C the engaging structures 8 include a hollow base 12 that extends outward from the outboard surface of the barrier panel 1 and a hollow catch portion 13 that extends outward from an outer side portion of the hollow base portion 12. The leading edge 14 of the hollow catch portion 13 is sloped or inclined inward so that the hollow catch portion 13 can slide by the peripheral edge 7 of opening 6 formed in a door panel 4. Once the hollow catch portion 13 clears the edge 7 of opening 6 it can engage the inner peripheral edge 7 of opening 6 as shown. The peripheral edge 7 of opening 6 can be recessed as depicted to accommodate the length of the engaging structures 8.

FIG. 5C shows the position of the adhesive bead 2 from FIG. 5A. As can be seen, the manner in which the engaging structure 8 pulls the barrier panel 1 towards the inboard surface of the door panel 4 causes pressure to be applied to the adhesive bead 2, thereby ensuring that a good seal is formed by the adhesive bead 2 which will contain moisture. It is to be understood that the amount of force created by the engaging structures 8, which at a minimum should be sufficient to hold the barrier panel 1 in place during assembly of a door assembly, is determined in part by the length of the engaging structures 8 and the amount the peripheral edge 7 of the opening 6 in a door panel 4 is recessed. Other determining factors include the number of engaging structures 8, the resilience of the material from which the engaging structures 8 and barrier panel 1 are made, the configuration and arrangement of the engaging structures 8, etc.

The barrier panel 1 depicted in FIGS. 4-5C includes as a grid structure 15 (also shown in FIGS. 2-3C) that can, for example be channels formed in one side of the barrier panel 1 so that the walls of the channels structurally reinforce the central portion of the barrier panel 1. Alternatively, when the barrier panel 1 is made from two or more sheets, the grid structure 15 represents channels in one or more of the individual sheets along the bottoms of which adjacent sheets are bonded together to structurally reinforce the barrier panel. Of course, in addition to a grid structure 15 that is illustrated discrete channels, depressions, indentations, etc. could be used. As noted above, when the barrier panel comprises two or more sheets that are bonded together, areas in the space between adjacent sheets can be hollow or can contain or be filled with acoustic and/or thermal insulation materials such as noise absorbing materials or materials with low thermal conductivity.

FIGS. 2-5C depict non-limiting examples of the shape and configuration of engaging structures that can be used according to the present invention. The illustrated engaging structures can be formed, e.g. molded, integrally with the barrier panels. Such integrally formed engaging structures 8 can be solid, hollow or semi-hollow or can comprise portions that are solid, hollow and/or semi-hollow. For example, the catch portion 13 shown in FIG. 5C could be solid and the base portion 12 could be hollow. In alternative embodiments the engaging structures 8 can be made separately from the barrier panels 1 and attached or fixed thereto by adhesives, thermal or ultrasonic welding, mechanical fasteners, cooperating engaging structures, etc. In such alternative embodiments in which the engaging structures 8 are made separately from the barrier panels 1 and attached or fixed thereto, the engaging structures 8 or parts thereof could be made from different materials than then barrier panels 1, including metals. In further embodiments at least some of the engaging structures 8 could be configured to engage with through-holes provided in the inboard surface of door panels. In such an instance, such engaging structures 8 could be similar in form to conventional push-in fasteners.

In further embodiments of the present invention the engaging structures 8 can comprise structural elements that pivot, rotate, deflect or otherwise move between an “open” position in which the engaging structure do not engage a door panel and a “closed” position in which the engaging structures engage a door panel. The movement of the structural elements of the engaging structures 8 between their open and closed positions are effected by other structural elements that are positioned and configured to contact the door panel while the barrier panels 1 are being installed.

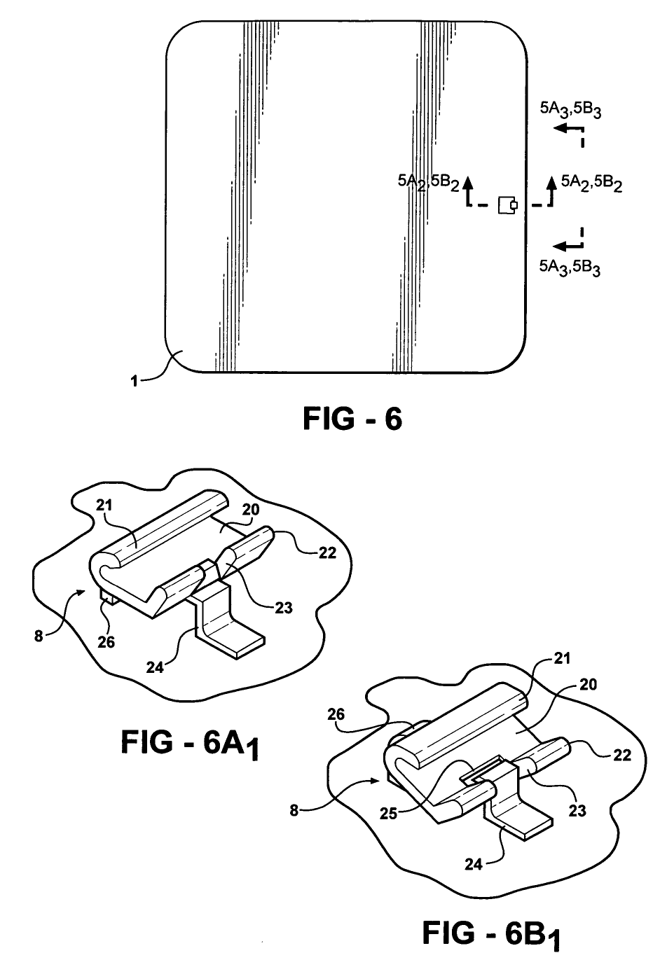

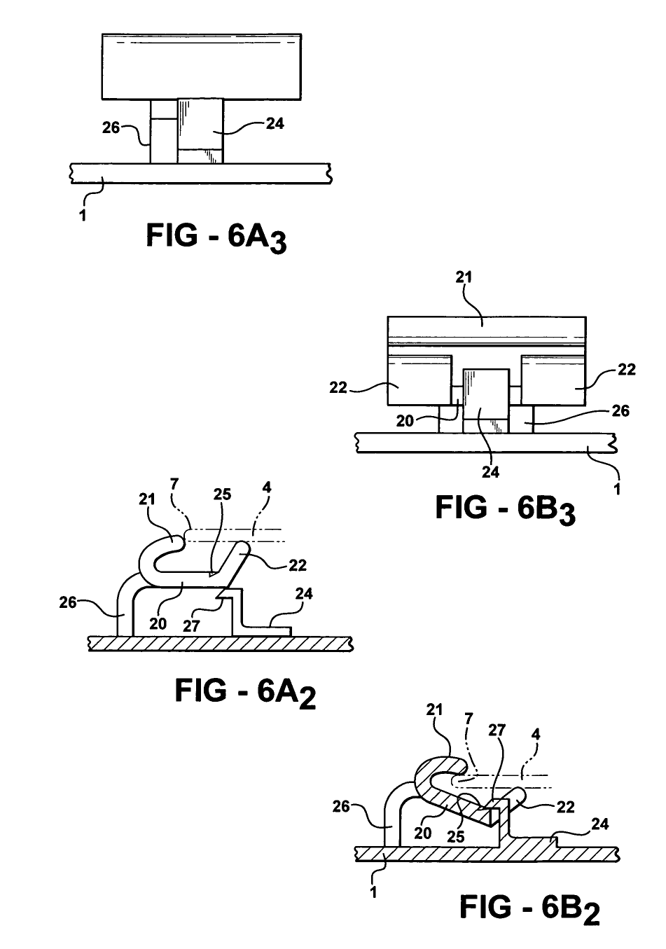

FIG. 6 is a top planar view of a barrier panel having an engagement structure according to another embodiment of the present invention. In FIG. 6 the outboard side of the barrier panel 1 is shown with one engaging structure 8 positioned near the peripheral edge of the barrier panel 1. FIG. 6 is presented as showing a simple barrier panel 1, it being understood that the barrier panel 1 can be contoured and shaped to conform to a particular door panel as noted above and could include reinforcing features or be made from two or more sheets of material as noted above. In addition, even though one engaging structure 8 is shown for simplicity, it is to be understood that any number of engaging structures 8 can be provided and arranged to engage the opening or openings formed in the inboard side of a door panel.

FIG. 6A, is a perspective view of the engagement structure of FIG. 6 in the engagement structure's open position. The engaging structure 8 includes a base 20, which in the illustrated embodiment is somewhat elongated, but could be square-shaped. An engaging lip 21 is provided on a rear portion of the base 20 and extends toward the front of the engaging structure 8. As will be described in more detail below, the engaging lip 21 is configured to extend over and engage an edge of an opening formed in the inboard side of a door panel.

A deflector 22 is formed on a front portion of the base 20 and is configured to cause the engaging lip 21 to engage an edge of an opening formed in the inboard side of a door panel when the deflector 22 come into contact with the inboard surface of the door panel. In the embodiment illustrated in FIG. 5A₁ the deflector 22 has a cut-out center portion 23 which is configured to receive a latch element 24 that is mounted in front of the engaging structure 8 on the outboard surface of the barrier panel 1 as shown in FIGS. 6A₂ and 6B₂. The base 20 of the engaging structure 8 includes a recess 25 near the cut-out central portion 23 which is configured to be engaged by the latch element 24.

The engaging structure 8 is supported on a bendable post 26 that can extend across the entire length of the base 20 or only a portion of the length of the base 20.

FIG. 6A, depicts the engaging structure in an “open” position in which the base 20 of the engaging structure 8 is above the latch element 24.

FIG. 6B, is a perspective view of the engagement structure of FIG. 6 in the engagement structure's closed position. When the engaging structure 8 is in the “closed” position, the free end 27 of latch element 24 extends within the cut-out portion 23 of the deflector 22 and engages the recess 25 formed in the base 20.

FIG. 6A₂ is a cross-sectional end view of the engagement structure of FIG. 6 in the engagement structure's open position. FIG. 6B₂ is a cross-sectional end view of the engagement structure of FIG. 6 in the engagement structure's closed position. The edge 7 of an opening of a door panel 4 is shown in phantom in FIG. 6A₂. As shown, the free or distal end of deflector 22 is configured to contact the door panel 4 as the barrier panel 1 with the engaging structure(s) 8 provided thereon is moved toward the door panel 4. After the free or distal end of the deflector 2 contacts the door panel 4, further movement, e.g. pushing, of the barrier panel 1 towards the door panel 4 causes the deflector 22 to deflect the front portion of engaging structure 8 downwards toward the barrier panel 1. As the front portion of engaging structure 8 deflects downwards, the engaging lip 21 pivots (clockwise in FIGS. 6A₂ and 6B₂) so that the free or distal end of the engaging lip 21 extends over the edge 7 of the opening in the door panel 4, thereby engaging the door panel 4.

In addition, after the free or distal end of the deflector 2 contacts the door panel 4, further movement, e.g. pushing, of the barrier panel 1 towards the door panel 4 causes the free end 27 of the latch element 24 to defect forward after initially contacting an edge of the base 20 within the cut-out portion 23 of the deflector 22. The free end 27 of the latch element 24 has a slopped or angled edge which causes the latch element 24 to be deflected forward away from the base 20. After the edge of the base 20 within the cut-out portion 23 of the deflector 22 passes by the free end 27 of the latch element 24 the free end 27 of the latch element 24 moves rearward and engages recess 25 near the cut-out central portion 23 thereby latching of locking the engaging structure 8 in the closed position depicted in FIG. 6B₂ with the edge 7 of the opening of the door panel 4 fully engaged by the engaging structure 8.

The bendable post 26 which supports the engaging structure 8 is configured to bend or deflect so as to allow the engaging lip 21 to pivot from the open position shown in FIG. 6A₂ into the closed position shown in FIG. 6B₂. In addition, the bendable post 26 and/or the latch element 24 are sufficiently bendable or deflectable to allow the free end 27 of the latch element 24 to clear the edge of the base 20 within the cut-out portion 23 of the deflector 22 as the barrier panel 1 is pushed toward the door panel 4.

FIG. 6A₃ is a rear view of the engagement structure of FIG. 6 in the engagement structure's open position. FIG. 6B₃ is a front view of the engagement structure of FIG. 6 in the engagement structure's open position. As shown in FIGS. 6A₃ and 6B₃ (together with FIG. 5B₁), the bendable post 26 can extend less than the entire length of the base 20 of the engaging structure 8 and can be off-set from the center, if desired.

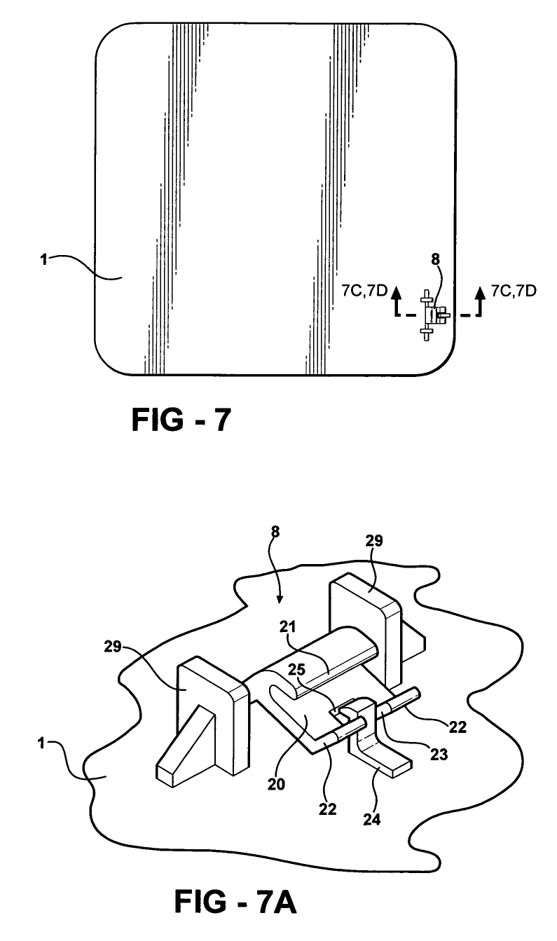

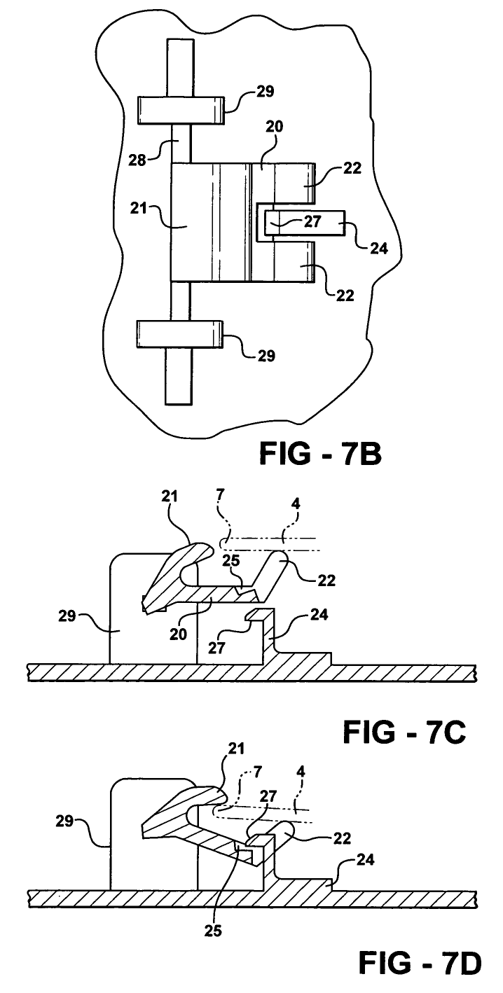

FIG. 7 is a top planar view of a barrier panel having an engagement structure according to another embodiment of the present invention. In FIG. 7 the outboard side of the barrier panel 1 is shown with one engaging structure 8 positioned near the peripheral edge of the barrier panel 1. FIG. 6 is presented as showing a simple barrier panel I it being understood that the barrier panel 1 can be contoured and shaped to conform to a particular door panel as noted above and could including reinforcing features or be made from two or more sheets of material as noted above. In addition, even though one engaging structure is shown for simplicity, it is to be understood that any number of engaging structures can be provided and arranged to engage the opening or openings formed in the inboard side of a door panel.

FIG. 7A is a perspective view of the engagement structure of FIG. 7 in the engagement structure's closed position. The engaging structure 8 shown in FIG. 7A includes a base 20, which in the illustrated embodiment is somewhat elongated, but could be more square-shaped. An engaging lip 21 is provided on a rear portion of the base 20 and extends toward the front of the engaging structure 8. As will be described in more detail below, the engaging lip 21 is configured to extend over and engage an edge of an opening formed in the inboard side of a door panel.

A deflector 22 is formed on a front portion of the base 20 and in configured to cause the engaging lip 21 to engage an edge of an opening formed in the inboard side of a door panel when the deflector 22 comes into contact with the inboard surface of the door panel. In the embodiment illustrated in FIG. 7A the deflector 22 has a cut-out center portion 23 which is configured to receive a latch element 24 that is mounted in front of the engaging structure 8 on the outboard surface of the barrier panel 1 as shown in FIGS. 7C and 7D. The base 20 of the engaging structure 8 includes a recess 25 near the cut-out central portion 23 which is configured to be engaged by the latch element 24.

The engaging structure 8 is supported on a bendable beam 28 (FIG. 7B) that is supported on either end by supports 29. As shown, the supports 29 are preferably braced to withstand the bending/twisting of the beam 28 that is discussed below.

FIG. 7A depicts the engaging structure in a “closed” position in which the latch element 24 over and engages recess 25 provide in the base 20 near the cut-out central portion 23 of the deflector 22.

FIG. 7B is a planar top view of the engagement structure of FIG. 7. In FIG. 7B the engaging structure 8 is depicted in its closed position and it can be seen how the free end 27 of the latch element 24 extends over the front edge of the base 20 through the cut-out central portion 23 of the deflector 22.

FIG. 7C is a cross-sectional end view of the engagement structure of FIG. 7 in the engagement structure's open position. FIG. 7D is a cross-sectional end view of the engagement structure of FIG. 7 in the engagement structure's closed position. The edge 7 of an opening of a door panel 4 is shown in phantom in FIG. 7C. As shown, the free or distal end of deflector 22 is configured to contact the door panel 4 as the barrier panel 1 with the engaging structure(s) 8 provided thereon is moved toward the door panel 4. After the free or distal end of the deflector 2 contacts the door panel 4, further movement, e.g. pushing, of the barrier panel 1 towards the door panel 4 causes the deflector 22 to deflect the front portion of engaging structure 8 downwards toward the barrier panel 1. As the front portion of engaging structure 8 deflects downwards, the engaging lip 21 pivots (clockwise in FIGS. 7C and 7D) so that the free or distal end of the engaging lip 21 extends over the edge 7 of the opening in the door panel 4, thereby engaging the door panel 4.

In addition, after the free or distal end of the deflector 22 contacts the door panel 4, further movement, e.g. pushing, of the barrier panel 1 towards the door panel 4 causes the free end 27 of the latch element 24 to defect forward and away from the base 20 after initially contacting an edge of the base 20 within the cut-out portion 23 of the deflector 22. The free end 27 of the latch element 24 has a slopped or angled edge which causes the latch element 24 to be deflected forward. After the edge of the base 20 within the cut-out portion 23 of the deflector 22 passes by the free end 27 of the latch element 24 the free end 27 of the latch element 24 moves rearward and engages recess 25 near the cut-out central portion 23 thereby latching of locking the engaging structure 8 in the closed position depicted in FIG. 7D with the edge 7 of the opening of the door panel 4 fully engaged by the engaging structure 8.

The bendable beam 28 which supports the engaging structure 8 is configured to bend/twist so as to allow the engaging lip 21 to pivot from the open position shown in FIG. 7C into the closed position shown in FIG. 7D. In addition, the bendable beam 28 and/or the latch element 24 are sufficiently bendable or deflectable to allow the free end 27 of the latch element 24 to clear the edge of the base 20 within the cut-out portion 23 of the deflector 22 as the barrier panel 1 is pushed toward the door panel 4.

The various elements of the engaging structures depicted in FIGS. 6-7D can be produced, e.g. molded, separately and assembled together and attached to the barrier panels. Otherwise various ones of the elements can be produced, e.g. molded as unitary assemblies or even provided as integral to the barrier panels.

To assemble a door assembly using the barrier panels having the engaging structures thereon, one removes any release sheet that covers the adhesive bead and pushes the barrier panel against the inboard surface of a door panel so that each of the engaging structures engage an edge of the opening(s) formed in the inboard surface of the door panel. Next, an inner trim panel is attached to the door panel over the barrier panel using conventional fasteners, such as push-in fasteners which are receive in through-holes provided in the inboard surface of the door panel.

The barrier panels and door assemblies of the present invention can be used in conjunction with any type of vehicle door assembly, including front and rear door assemblies, sliding door assemblies, and rear door assemblies.

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as described above.

What is claimed is:

1. A barrier panel for a vehicle door assembly having a door panel, which barrier panel comprises:
a sheet of substantially water-impermeable material that is substantially complimentarily shaped to the door panel and includes an inboard surface and an outboard surface; and
at least one engaging structure provided on the outboard surface of the sheet of substantially water-impermeable material and being configured to engage a peripheral edge of an opening formed in an inboard surface of the door panel, the at least one engaging structure having a portion that is stationary with respect to the sheet of substantially water-impermeable material and a portion that is movable with respect to the sheet of substantially water-impermeable material between an open position in which the at least one engaging structure does not engage the opening formed in an inboard surface of the door panel and a closed position in which the at least one engaging structure engages the opening formed in an inboard surface of the door panel.

2. The barrier panel for a vehicle door assembly having a door panel according to claim 1, wherein the movable portion of the at least one engaging structure is pivotally coupled to the sheet of substantially water-impermeable material.

3. The barrier panel for a vehicle door assembly having a door panel according to claim 2, wherein the movable portion of the at least one engaging structure is pivotally coupled to the sheet of substantially water-impermeable material by a bendable post.

4. The barrier panel for a vehicle door assembly having a door panel according to claim 2, wherein the movable portion of the at least one engaging structure is pivotally coupled to the sheet of substantially water-impermeable material by a bendable beam.

5. The barrier panel for a vehicle door assembly having a door panel according to claim 4, wherein the bendable beam is supported on the sheet of substantially water-impermeable material by support members.

6. The barrier panel for a vehicle door assembly having a door panel according to claim 1, wherein movable portion of the at least one engaging structure includes a defector which is configured to contact the door panel and cause the movable portion to pivot between the open position to the closed position.

7. The barrier panel for a vehicle door assembly having a door panel according to claim 1, wherein the movable portion of the at least one engaging structure includes an engaging lip that is configured to extend over the peripheral edge of the opening formed in the inboard surface of the door panel when the movable portion is in the closed position.

8. The barrier panel for a vehicle door assembly having a door panel according to claim 1, wherein the stationary portion comprises a latch that is configured to engage and secure the movable portion in the closed position.

9. The barrier panel for a vehicle door assembly having a door panel according to claim 1, wherein the movable portion and the stationary portion are disconnected from one another when the at least one engaging structure is in the open position.

10. An engaging structure provided on a barrier panel of a door assembly that comprises:
a movable portion having a base provided with an engaging lip and a deflector; and
a latch element that is stationary with respect to the barrier panel and configured to engage the movable portion.

11. The engaging structure of claim 10, wherein the engaging lip and the deflector are on opposite portions of the base.

12. The engaging structure of claim 10, wherein the deflector has a central opening provided therein.

13. The engaging structure of claim 10, wherein the movable portion is pivotally coupled to the barrier panel.

14. The engaging structure of claim 13, wherein the movable portion is pivotally coupled to the barrier panel by a bendable post.

15. The engaging structure of claim 13, wherein the movable portion is pivotally coupled to the barrier panel by a bendable beam.

16. The engaging structure of claim 15, wherein the bendable beam is supported on the barrier panel by support members.

17. The engaging structure of claim 10, wherein movable portion and the latch element are disconnected from one another when the engaging structure is in an open position.

18. The engaging structure of claim 10, wherein the latch element engages the base portion when the engaging structure is in a closed position and secures the engaging structure in the closed position.

19. A door assembly that comprises the barrier panel of claim 1.

10. A door assembly that comprises the engaging structure of claim 10.
